(19) United States
(12) Patent Application Publication
(10) Pub. No.: US 2005/0093279 A1
(43) Pub. Date: May 5, 2005

(54) Gas bag module

(75) Inventors: Constantin Hauer, Schoellkrippen (DE); Alexander Limberger, Muehlheim (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive Safety Systems GmbH

(21) Appl. No.: 10/959,570

(22) Filed: Oct. 6, 2004

(30) Foreign Application Priority Data
Oct. 31, 2003 (DE) 203 16 817.8

(51) Int. Cl. B60R 21/16

(52) U.S. Cl. 280/740

(57) ABSTRACT

A gas bag module (10) includes a gas bag (56) having a front wall, a center section (58) of the front wall being fastened to the gas bag module (10) and being prevented from a free movement on an unfolding of the gas bag (56). The gas bag module (10) further includes a diffusor (22) having a first diffusor element (24) fixed to the module, and a second diffusor element (26) displaceable with respect to the first diffusor element (24) by a predetermined limited displacement path (d) in an axial direction (A). The gas bag module further comprises a gas generator (16) arranged below the diffusor (22) and a covering cap (42) having a central section (50) which is fastened by at least one fastening means to the second diffusor element (26; 326; 326′). The diffusor elements (24, 26) are constructed so that the second diffusor element (26) is not displaceable in a peripheral direction (U) relative to the first diffusor element (24).

### TECHNICAL FIELD

The invention relates to a gas bag module, in particular to a gas bag module comprising a gas bag having a front wall, a center section of the front wall being fastened to the gas bag module and being prevented from a free movement upon deployment of the gas bag.

### BACKGROUND OF THE INVENTION

The gas bags of such gas bag modules, which are preferably employed in steering wheels, unfold in a ring shape around a substantially stationary central part of the gas bag module. The inner opening of the ring is closed by suitable means which are known to the artisan, such that in the inflated state of the gas bag no part of a vehicle occupant's body can unintentionally penetrate into the ring.

This type of gas bag modules advantageously avoids free movement of parts of a covering cap through the interior of the vehicle. This applies in particular to the central part of the covering cap, which is often used to fasten heavy and bulky emblems, e.g. a logo of the vehicle manufacturer.

As in other conventional gas bag modules the problem of reliably freeing the outlet opening for the gas bag in the shortest period of time possible on activation of the gas bag module.

From published German Patent Application DE 100 36 759 A1 it is known to lift the central part of the covering cap upon deployment of the gas bag and to thus provide a ring-shaped outlet opening. The lifting is caused by a diffusor arranged underneath the central part of the covering cap. The diffusor has two segments inserted one into the other in a telescope manner. On activation of the gas bag module the segments are pushed apart due to the gas pressure of the gas emerging from the gas generator.

### SUMMARY OF THE INVENTION

It is an object of the invention to provide a gas bag module which ensures a rapid freeing of the outlet opening and a reliable deployment of the gas bag.

The gas bag module according to the invention comprises a gas bag having a front wall, a center section of the front wall being fastened to the gas bag module and being prevented from a free movement upon deployment of the gas bag. The gas bag module according to the invention further comprises a diffusor having a first diffusor element, fixed to the module, and a second diffusor element displaceable with respect to the first diffusor element by a predetermined limited displacement path in an axial direction. The gas bag module according to the invention further comprises a gas generator arranged below the diffusor, and a covering cap having a central section which is fastened by at least one fastening means to the second diffusor element. The diffusor elements are constructed so that the second diffusor element is not displaceable in a peripheral direction relative to the first diffusor element. Through this construction, a rotation of the diffusor elements relative to each other perpendicularly to the direction of the displacement path is prevented. Thus, it is ensured that the gas bag assumes a precisely defined position in the space after its unfolding.

In a preferred embodiment of the invention, relative rotation between the diffusor elements is prevented in that a portion of one of the diffusor elements engages through an outflow opening provided on the other one of the diffusor elements.

In addition, the portion may form a stop for delimiting the displacement path, so that the movable second diffusor element, after traveling the displacement path, can be “caught” by the first diffusor element which is fixed to the vehicle.

In a further preferred embodiment, the diffusor elements have structures mutually engaging each other in a plane perpendicular to the axial direction, preventing a relative movement of the two diffusor elements. In this case, the rotation is prevented by a peripheral geometry deviating from the circular shape in a plane perpendicular to the axial direction or to the displacement path.

Projections can be formed on the diffusor elements, pointing in a radial direction, for example.

The various measures of preventing relative rotation of the diffusor elements can of course also be combined with each other.

In the first and/or in the second diffusor element, outflow openings can be provided, which are cleared during the displacement of the second diffusor element. This is favourable in order, for example, to use at least a portion of the gas emerging from the gas generator to lift the second diffusor element firstly and via this to open or lift the covering cap. In addition, the inflow of the gas into the gas bag can thus be controlled in line with specific objectives in the initial phase of the unfolding of the gas bag.

The second diffusor element may be constructed so as to be substantially gas-tight. In this case, firstly the central part of the covering cap is lifted before the gas begins to flow into the gas bag to unfold it.

In another embodiment, provision is made that the second diffusor element has outflow openings which are at least partially never covered by the first diffusor element. Here, the gas generated by the gas generator flows directly into the gas bag after activation of the gas bag module. The force of the unfolding gas bag can contribute at least partially to the lifting and opening of the covering cap.

Preferably, the second diffusor element is guided by the first diffusor element during the displacement along the displacement path.

In one embodiment, the central section of the covering cap is connected with the remaining covering cap by means of nominal fracture sites or hinges. In this case, a ring-shaped outlet opening for the gas bag around the central part of the covering cap is freed.

Alternatively, it is possible to lift the entire covering cap upon deployment of the gas bag. Here, also, a ring-shaped outlet opening is freed for the gas bag, which is formed for example by a gap opened between an edge of the covering cap and a module housing. The advantage here is that hinges or nominal fracture sites can be dispensed with in the region of the front side of the covering cap which is visible from the exterior.

Preferably, a portion of a generator carrier and/or an edge of an inflation opening of the gas bag is clamped between a ring formed on the first diffusor element and the module housing. In this way, a separate gas bag holding element can be dispensed with, because a section of the first diffusor element undertakes this task.

The gas generator can be mounted so as to be capable of oscillating. The space necessary for this can be provided simply below the second diffusor element in its normal position before the activation of the gas bag module.

### BRIEF DESCRIPTION OF THE DRAWINGS

Further features and advantages of the invention will be apparent from the following description in connection with the accompanying figures.

FIG. 1 shows a diagrammatic sectional view of one half of a gas bag module according to the invention in accordance with a first embodiment;

FIG. 2 shows a diagrammatic view of one half of a gas bag module according to the invention in accordance with a second embodiment;

FIG. 3 shows on the right-hand side a diagrammatic sectional view of one half of a gas bag module according to the invention in accordance with a third embodiment and on the left-hand side a diagrammatic sectional view of one half of a gas bag module according to the invention in accordance with a variant of the third embodiment;

FIG. 4 shows a sectional view along the line IV-IV in FIG. 1 in accordance with a first variant;

FIG. 5 shows a sectional view along the line IV-IV in FIG. 1 in accordance with a second variant; and

FIG. 6 shows a sectional view along the line IV-IV in FIG. 1 in accordance with a third variant.

### DETAILED DESCRIPTION OF THE PREFERRED EMBODIMENTS

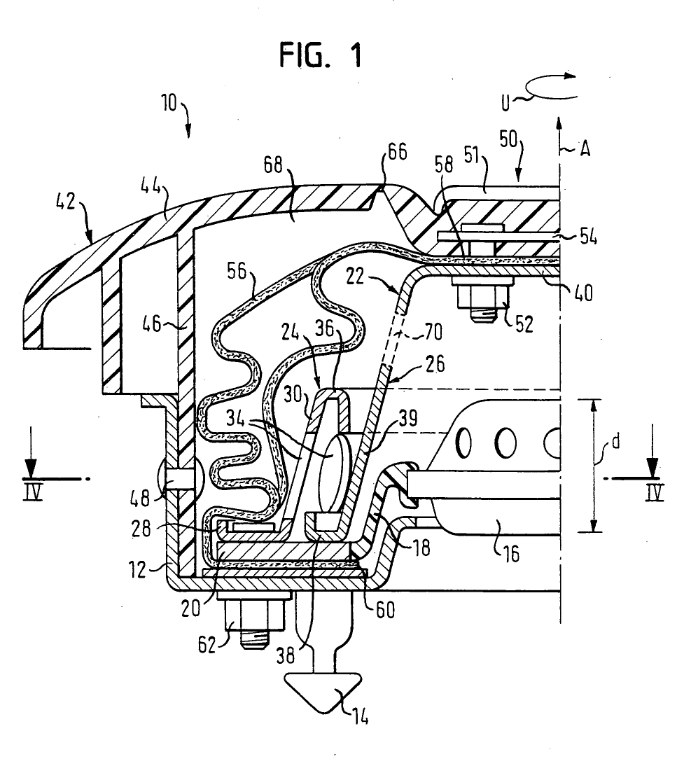

The gas bag module 10 shown in FIG. 1 contains a module housing 12, on the base of which detent elements 14 are provided for fastening the gas bag module 10 in a steering wheel. In the module housing 12 a gas generator 16 is held, mounted so as to be capable of oscillating. The gas generator 16 is connected with a flat ring-shaped flange 20 by means of an elastic ring-shaped element 18. The flange 20 here fulfils the task of a generator carrier.

The gas generator 16 is arranged below a two-part diffusor 22, which has a first diffusor element 24, fixed to the module, and a second diffusor element 26 displaceable with respect to the first diffusor element 24 by a predetermined displacement path d parallel to an axial direction A of the gas bag module 10.

The first diffusor element 24, positioned radially on the exterior, has at its base, which is directed radially outward, a ring 28 which rests on the flange 20. The ring 28 connects the flange 20 and also an edge 60 of an inflation opening of a folded gas bag 56 accommodated in the module housing 12, by means of fastening elements 62 known per se with the module housing 12. By means of the fastening elements 62, the first diffusor element 24 is also connected securely with the module housing 12 and, via the housing 12, securely with the steering wheel.

Adjoining the ring 28 radially inwards is a frustum-shaped section 30, which is provided with radially directed outflow openings 34.

In axial direction A upwards, the first diffusor element 24 terminates in a ring-shaped, radially inwardly bent edge 36.

The second diffusor element 26 has at the lower end, with respect to the axial direction A, a radially outwardly bent edge 38 facing a base of the module housing 12. The edge 38 is complementary in its shape to the edge 36 of the first diffusor element 24. Adjoining the edge 38 is a frustum-shaped section 39, which at the upper end of the second diffusor element 26, with respect to the axial direction A, turns into a flat cover plate 40.

The gas bag module 10 is closed towards the exterior, i.e. in the direction of a vehicle interior with respect to an installed state in the steering wheel by a covering cap 42. The covering cap 42 is fastened securely to the module housing 12 via side walls 46 projecting perpendicularly from an end wall 44 by means of a rivet connection 48. The covering cap 42 mainly consists of a suitable plastic.

A central section 50 of the covering cap 42, on which here an emblem 51 is fastened, is securely connected with the cover plate 40 of the second diffusor element 26 by means of a screw connection 52. A metal insert 54 on which the screw connection 52 engages is cast or injected into the plastic material of the central section 50 of the covering cap 42. In this way, the central section 50 is securely fastened to the gas bag module 10 and is prevented from a free movement on an activation of the gas bag module 10.

A center section 58 of a front wall of the gas bag 56 is securely fastened between the central section 50 of the covering cap 42 and the cover plate 40 of the second diffusor element 26 by means of the screw connection 52, so that the center section 58 is also prevented from a free movement on the activation of the gas bag module 10 and subsequent unfolding of the gas bag 56. When inflated, the gas bag 56 has a ring-shaped form, an indentation being formed over the central section 50 of the covering cap 42. This construction of the gas bag 56 is not illustrated here, but is known to the artisan.

The diffusor 22 is constructed so that the second diffusor element 26 can move in axial direction A with respect to the first diffusor element 24 along a predetermined limited displacement path d. By the lifting of the second diffusor element 26, the central section 50 of the covering cap 42, securely connected therewith, is also lifted. After traveling the displacement path d, the edge 38 of the second diffusor element 26 comes into engagement with the edge 36 of the first diffusor element 24, which acts as a stop and thus stops the movement of the second diffusor element 26. The movement of the second diffusor element 26 is triggered with the activation of the gas bag module 10 by the increased internal pressure inside the module housing 12, which is generated by the gas emerging from the gas generator 16.

In the first embodiment shown in FIG. 1, on lifting the second diffusor element 26, the covering cap 42 tears open at nominal fracture sites 66, which surround the central section 50, so that a ring-shaped outlet opening 68 is freed for the gas bag 56.

In a first variant, the second diffusor element 26 is constructed so as to be substantially gas-tight, so that the gas flowing out from the gas generator 16 initially does not have a flow path into the gas bag 56. As a result, initially the pressure beneath the second diffusor element 26 increases, so that firstly the second diffusor element 26 is lifted. Through this movement, the covering cap 42 can already open at the nominal fracture sites 66.

However, it is also possible that the final opening of the covering cap 42 is only brought about through the unfolding of the gas bag 56, which begins to fill as soon as the edge 38 at the base of the second diffusor element 26 passes the outflow openings 34 in the first diffusor element 24 and thereby clears them. From this moment, gas can flow into the gas bag 56 and begin to unfold it.

In a second variant, the second diffusor 26 is constructed so as to be at least partially gas-permeable, by outflow openings 70 (shown in dashed lines) being provided, which always allow a gas flow into the gas bag 56. In this case, gas flows immediately through the outflow openings 70 into the gas bag 56. Here, the unfolding gas bag 56 can then also contribute to the lifting of the second diffusor element 26.

Between the first diffusor element 24 and the second diffusor element 26, a securing mechanism against rotation is provided, which prevents a relative movement of the two diffusor elements 24, 26 in a peripheral direction U perpendicularly to the axial direction A. The peripheral direction U may refer both to a clockwise movement and also an anticlockwise movement in relation to the axial direction A. Thus, the final position of the inflated gas bag is ensured, and a torsion between the center section 58 of the gas bag 56 and the parts of the gas bag 56 lying radially outwards is avoided.

In order to prevent a relative movement of the two diffusor elements 24, 26 in peripheral direction U, the peripheral geometry of the diffusor elements 24, 26 is selected here, in a plane perpendicular to the axial direction A, so as to deviate from a circular shape. On each of the two diffusor elements 24, 26, structures are provided which point in a radial direction r, the structures on the second diffusor element 26 engaging into those of the first diffusor elemnet 24 or vice versa.

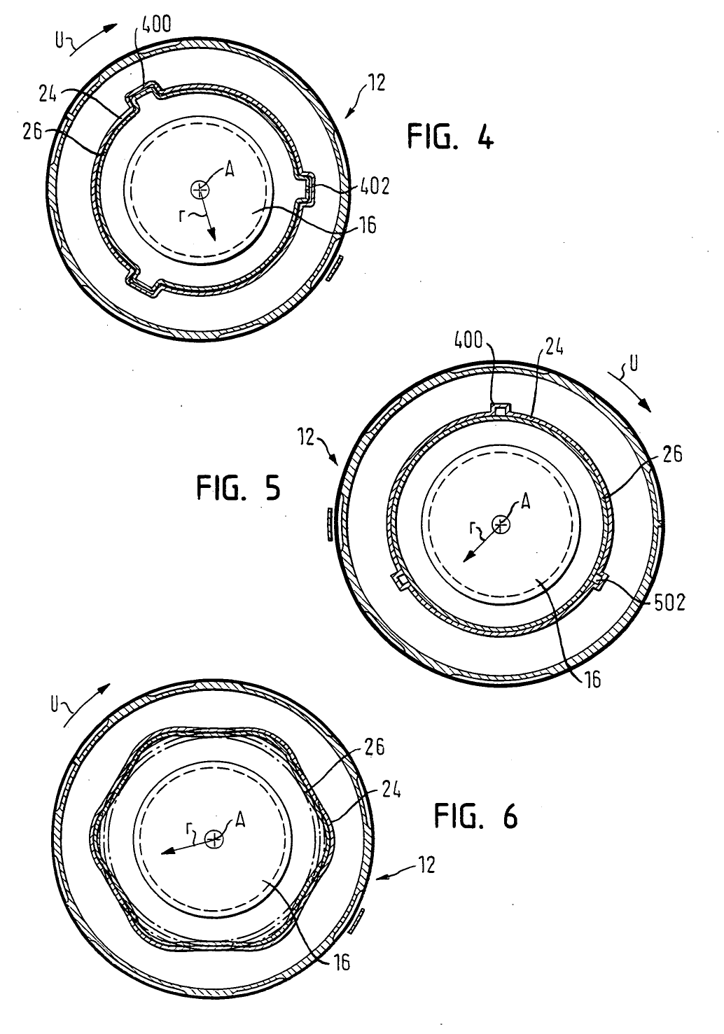

In the example shown in FIG. 4, both the first diffusor element 24 and also the second diffusor element 26 respectively have three radially outwardly directed projections 400 and 402, respectively, distributed over the periphery. The projection 402 of the inner second diffusor element 26 engages into the projection 400 of the first diffusor element 24. The diffusor elements 24, 26 are arranged congruent in their shape and coaxial with each other. In axial direction A the projections 400, 402 extend over the entire displacement path d.

The diameter proportions of the diffusor elements 24, 26 are selected so that the second diffusor element 26, on traveling the displacement path d, is guided by the inner wall of the first diffusor element 24.

In the construction of the diffusor elements 24, 26 shown in FIG. 5, axial ribs 502 are arranged on the outer periphery of the second diffusor element 26, which fulfil the same function as the projections 402 described above.

In FIG. 6 an example is shown, in which the entire outer periphery of both diffusor elements 24, 26 is constructed so as to deviate from the circular shape at least in the region of the displacement path d. Here, also, the diffusor elements 24, 26 are congruent to each other in the illustrated sectional plane. The diffusor elements 24, 26 are arranged coaxially with each other, an outer side of the second diffusor element 26 lying against an inner side of the first diffusor element 24. In a plane perpendicular to the axial direction A, the two diffusor elements 24, 26 have the shape of a hexagonal star with rounded comers. In the region of the lower edges 28, 38 facing away from the covering cap 42, the cross-section of both diffusor elements 24, 26 is circular.

The structures, i.e. the projections 400, 402 or the ribs 502 or the star-shaped peripheral contour, respectively, are produced here through a shaping of the walls of the diffusor elements 24, 26. Of course, other suitable methods can also be used. The ribs 502 may, however, also be separate elements which are fastened to the second diffusor element 26. It is also possible to have projections 400, 402 pointing radially inwards.

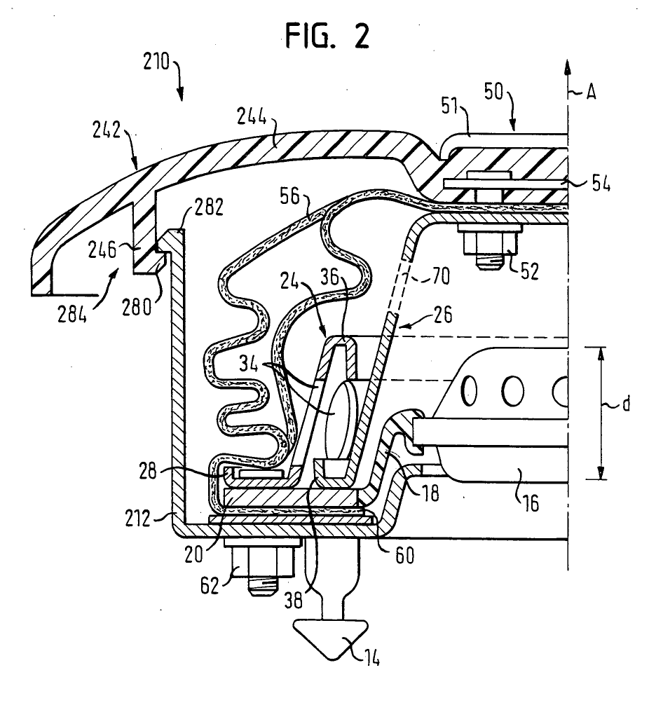

In FIG. 2 a second embodiment is shown. In the description of the second embodiment only the differences from the first embodiment will be entered into in detail. The reference numbers which are already known for components identical to the first embodiment are retained.

In this case, the covering cap 242 is not provided with nominal fracture sites, but rather is constructed so as to be rigid in itself.

On the side walls 246, which project perpendicularly from the end wall 244 of the covering cap 242, first detent elements 280 are formed, which engage into complementary detent elements 282 which are constructed on the edge of side walls of the module housing 212. The detent elements 280, 282 can be constructed for example as encircling strips which are formed on the side walls 246 of the covering cap 242 or on the module housing 212, respectively. However, individual detent hooks or any desired suitable combination can also be used.

On activation of the gas bag module 210, through the pressure building up inside the module housing 212, the detent connection 280, 282 is released. The second diffusor element 26 is lifted by the displacement path d in axial direction A, the entire covering cap 242 being moved by the displacement path d. This results in an outlet opening 284 for the gas bag 56 in the form of a ring-shaped gap between the edge of the module housing 212 and the edge of the side wall 246 of the covering cap 242.

Here, also, the first and the second diffusor element 24, 26 are prevented from a relative movement in peripheral direction U by means of one of the securing mechanisms against rotation described above, and are coordinated with each other so that the first diffusor element 24 guides the second diffusor element 26 during the displacement by the displacement path d.

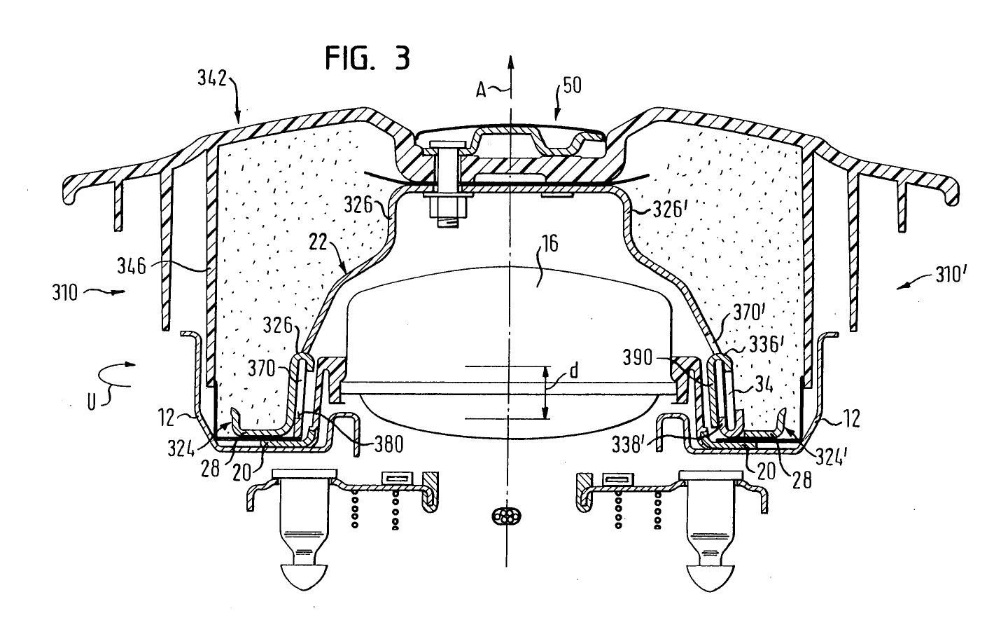

In the gas bag module 310 illustrated in the left half of FIG. 3, in accordance with a third embodiment of the invention, several outflow openings 370 are provided at the lower end of the second diffusor element 326 facing away from the covering cap 342. The outflow openings 370 are distributed over the periphery. In the region of the outflow openings 370, the upper edge 336 of the first diffusor element 324, which is directed to the covering cap 342, is bent radially inwards. The edge 336 projects radially inwards through the outflow openings 370 into the interior of the diffusor 22 and thus forms a stop for the lower edge 380 of the outflow opening 370 of the second diffusor element 326, facing away from the covering cap 342. In peripheral direction U the width of the section of the edge 336 corresponds approximately to the width of the outflow opening 370, so that during the movement of the second diffusor element 326 along the displacement path d, on the one hand a guiding of the second diffusor element 326 takes place and on the other hand a relative movement of the two diffusor elements 324, 326 in peripheral direction U is prevented. After the second diffusor element 326 has traveled the displacement path d and, in an analogous manner to the second embodiment, has lifted the entire covering cap 342 by the distance d, the lower edge 380 of the outflow opening 370 comes into engagement with the edge 336 of the first diffusor element 324, whereby the upwards movement of the second diffusor element 326 in axial direction A is stopped.

The fastening of the side walls 346 of the covering cap 342 on the module housing 12 can take place for example in the manner shown in FIG. 2 by means of a detachable detent connection.

Before the activation of the gas bag module 310, the second diffusor element 326 is fastened to the first diffusor element 324. The fastening is constructed so that in normal operation of the vehicle, i.e. before the activation of the gas bag module 310, the two diffusor elements 324, 326 can not detach themselves from each other. On activation of the gas bag module 310 the fastening opens without a time delay and allows a movement of the second diffusor element 326 in axial direction A. This fastening can take place for example in that at a few points along the peripheral direction U, the second diffusor element 326 is connected to the first diffusor element 324 e.g. by crimping in the region of the lower edge 380 of the outflow opening 370.

In the embodiment shown here, the first diffusor element 324 does not have any outflow openings, and in the second diffusor element 326 only the outflow openings 370 are provided in the lower marginal region of the second diffusor element 326 facing away from the covering cap 342. The outflow openings 370 are only cleared when the lifting of the second diffusor element 326 begins. After traveling the displacement path d, the outflow openings 370 are completely cleared.

In this case, in the initial phase, the gas flowing out from the gas generator 16 is used firstly for lifting the covering cap 342 and freeing the outlet opening for the gas bag, before the gas can flow off through the outflow openings 370 into the gas bag.

In the variant of the third example embodiment shown in the right half of FIG. 3, the height of the outflow openings 370′ in the second diffusor element 326′ is selected so that also in the shown normal state, before the start of the displacement of the second diffusor element 326′, a section of the outflow openings 370′ is cleared, i.e. not covered by the first diffusor element 324′. The remaining part of each outflow opening 370′ is only cleared during the displacement of the second diffusor element 326′ along the displacement path d. In this case, already immediately after the activation of the gas bag module 310′ a portion of the released gas flows through the outflow openings 370′ into the gas bag, so that the latter can contribute to the lifting of the covering cap 342.

Here, the first diffusor element 324′ also has outflow openings 34. A lower edge 338′ of the second diffusor element 326′, facing the base of the module housing 12 and bent radially outwards, projects through the outflow opening 34.

The upper edge 336′ of the first diffusor element 324′, facing the covering cap 342, is bent radially outwards. Here, in peripheral direction U, several sections 390 are formed, directed towards the base of the module housing 12. The dimension of the sections 390 in axial direction A corresponds approximately to the height of the outflow openings 34.

Before the beginning of the displacement of the second diffusor element 326′, the outflow openings 34 are closed by the sections 390 of the first diffusor element 324′ and also by the sections, adjoining thereto, of the edge 338′ of the second diffusor element 326′ in a nearly gas-tight manner. During the covering of the displacement path d by the second diffusor element 326′, the outflow openings 34 are cleared.

After covering the displacement path d, the section of the edge 338′ comes into engagement with the upper edge 336′ of the first diffusor element 324′, directed towards the covering cap 342, which forms a stop.

Here, also, the widths of both the outflow opening 370′ and the section 390 of the edge 336′ engaging through the outflow opening 370′, with respect to the peripheral direction U, are coordinated with each other so that a relative movement of the second diffusor element 326′ with respect to the first diffusor element 324′ in peripheral direction U is prevented, and the second diffusor element 326′, during the traveling of the displacement path d, is guided through the first diffusor element 324′.

At a few points along the periphery, the second diffusor element 326′ can be detachably secured to the first diffusor element 324′ in a suitable manner, e.g. in the contact region between the section 390 and the edge 338′ by crimping, glueing or the like.

All the features of the various embodiments and variants can be combined with each other at the discretion of the artisan.

1. A gas bag module, comprising
a gas bag (56) having a front wall, a center section (58) of the front wall being fastened to the gas bag module (10; 210) and being prevented from a free movement upon deployment of the gas bag (56),
a diffusor (22) having a first diffusor element (24; 324; 324′) fixed to the module, and a second diffusor element (26; 326; 326′) displaceable with respect to the first diffusor element (24; 324; 324′) by a predetermined limited displacement path (d) in an axial direction (A),
a gas generator (16) arranged below the diffusor (22), and
a covering cap (42; 242; 342) having a central section (50) which is fastened by at least one fastening means to the second diffusor element (26; 326; 326′),
the diffusor elements (24, 26; 324, 326; 324′, 326′) being constructed so that the second diffusor element (26; 326; 326′) is not displaceable in a peripheral direction (U) relative to the first diffusor element (24; 324; 324′).

2. The gas bag module according to claim 1, characterized in that a portion of one of the diffusor elements (324; 324′) engages through an outflow opening (370; 370′) provided on the other one of the diffusor elements (326; 326′).

3. The gas bag module according to claim 1, characterized in that the diffusor elements (24, 26) have structures mutually engaging each other in a plane perpendicular to the axial direction (A).

4. The gas bag module according to claim 3, characterized in that projections (400, 402; 500, 402) pointing in a radial direction (r) are formed on the diffusor elements (24, 26).

5. The gas bag module according to claim 1, characterized in that in at least one of the first and second diffusor elements (24, 26; 324, 326) outflow openings (34; 70; 370; 370′) are provided, which are cleared during the displacement of the second diffusor element (26; 326).

6. The gas bag module according to claim 1, characterized in that the second diffusor element (26) is constructed so as to be substantially gas-tight.

7. The gas bag module according to claim 1, characterized in that the second diffusor element (26; 326′) has outflow openings (70; 370′) which are at least partially never covered by the first diffusor element (24; 324′).

8. The gas bag module according to claim 1, characterized in that the second diffusor element (326; 326′) is guided through the first diffusor element (324; 324′) during the displacement along the displacement path (d).

9. The gas bag module according to claim 1, characterized in that the central section (50) of the covering cap (42) is connected with the remaining covering cap (42) by means of nominal fracture sites (66) or hinges.

10. The gas bag module according to claim 1, characterized in that upon deployment of the gas bag (56) the entire covering cap (242; 342) is lifted.

11. The gas bag module according to claim 1, characterized in that at least one of a portion of a generator carrier and an edge (60) of an inflation opening of the gas bag (56) is clamped between a ring (28) formed on the first diffusor element (24; 324; 324′) and the module housing (12).

12. The gas bag module according to claim 1, characterized in that the gas generator (16) is mounted so as to be capable of oscillating.
